(19) United States
(12) Patent Application Publication
(10) Pub. No.: US 2008/0263300 A1
(43) Pub. Date: Oct. 23, 2008

(54) Storage Media

(75) Inventor: Leonard H.D. Poll, Surrey (GB)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: NXP B.V., Eindhoven (NL)

(21) Appl. No.: 12/095,159

(22) PCT Filed: Nov. 2, 2006
(86) PCT No.: PCT/IB06/54057

§ 371 Date: May 28, 2008

(30) Foreign Application Priority Data
Nov. 29, 2005 (EP) 05111470.0
Nov. 2, 2006 (IB) PCT/IB2006/054057

(51) Int. Cl. G06F 12/14

(52) U.S. Cl. 711/163; 711/E12.091

(57) ABSTRACT

A storage media for storing data and comprising an integral controller configured to control access to the data depending on the location of the storage media. The storage media may further comprise means to determine its location, e.g. such as a GPS receiver or a cellular network positioning solution. Alternatively, the location may be provided by an external device.

This invention relates to storage media for storing data.

USB flash drives are perhaps the best example of the present genre of storage media comprising a solid state memory and an interface through which data is streamed between the memory and an external device with a corresponding interface. Whilst useful, such devices give rise to concerns about the ease with which large amounts of data and software can be transported in an unsecured manner. Protecting content is of course possible by conventional means such as password protecting certain files and folders on such drives, but remembering and typing in such passwords is often inconvenient and password protection is not infallible.

In accordance with the present invention, there is provided storage media for storing data and comprising an integral controller configured to control access to the data depending on the location of the storage media, and hence an additional and convenient layer of data protection. Such storage media may further comprise means to determine its location, e.g. such as a GPS receiver or a cellular network positioning solution. Alternatively, the location may be provided by an external device.

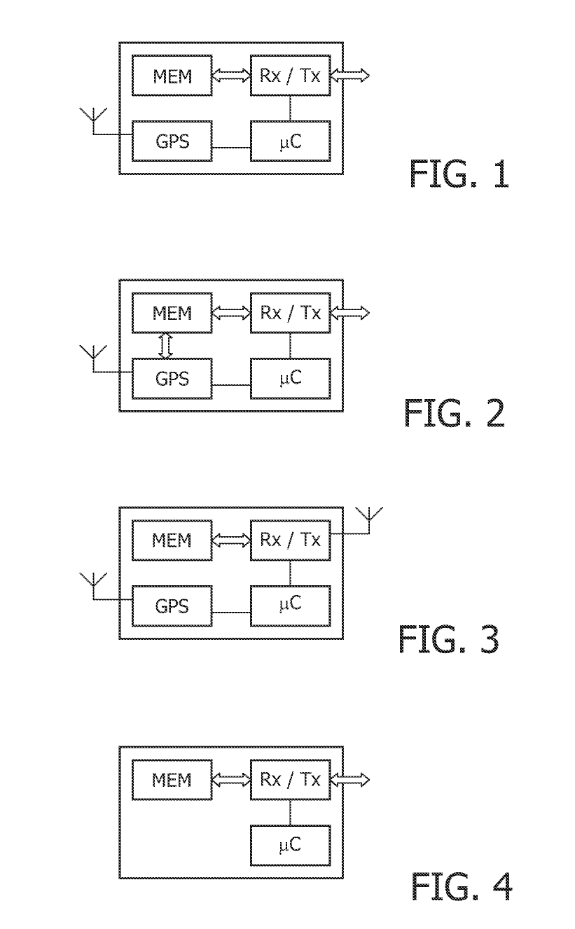

The invention will now be described, by way of example only, with reference to the accompanying drawings in which FIGS. 1 to 4 show, schematically, examples of storage media according to the present invention.

Example 1 FIG. 1 shows a USB flash memory drive with integral GPS receiver comprising a memory (MEM), a wired receiver/transmitter (Rx/Tx) interface, a GPS receiver and a microcontroller (μC). The GPS receiver determines and outputs its location to the microcontroller which determines, in accordance with the present invention, whether the location outputted by the GPS receiver corresponds to at least one predefined location stored by the drive. If it does correspond, the receiver/transmitter interface is set to an “unlocked” mode in which data may be streamed on and off the drive. If not, the receiver/transmitter interface is set to a “locked” mode in which data streaming on and off the drive is prevented. Such redefined locations may be set by the owner and/or administrator responsible for the flash drive and stored on the drive, e.g. by a user using a PC to which the drive can be connected.

Example 2 illustrated in FIG. 2. As example 1 except that a GPS software solution is implemented to determine the location of the drive. Hence, the drive comprises only a GPS RF front end which samples GPS signals receiver through its antenna and pre-process them, typically by passive bandpass filtering in order to minimise out-of-band RF interference, preamplification, down conversion to an intermediate frequency (IF) and analogue to digital conversion. The resultant GPS signal samples are then stored in the memory (Mem) from which they stream off the drive to an external PC platform (not shown) where the samples are processed to determine the location of the GPS RF front end. This location is provided to the drive's microcontroller (IC) which controls data access as described in example 1. To prevent location spoofing, it is desirable if trusted GPS software and/or dedicated driver software for the USB flash drive is used to ensure the integrity of the location supply to the drive.

Example 3 illustrated in FIG. 3. As example 1 except that data is streamed on and off the USB flash drive using a wireless receiver/transmitter (Rx/Tx). Depending on the specific nature of the wireless receiver/transmitter, the data could be accessed by nearby devices (e.g. with WiFi) or through a cellular telephone network. Instead of an internal GPS receiver, an estimate of the position of the storage media could be received from a nearby device with position determining means and transmitted to the short range using a short range wireless link.

Example 4 illustrated in FIG. 4. As example 1 except that the flash drive does not contain any means to either partially or completely determine its location; and rather relies on its location being provided by an external device to which the drive is connected. Again, as with example 2, to prevent location spoofing, it is desirable if trusted GPS software and/or dedicated driver software for the USB flash drive is used to ensure the integrity of the location supply to the drive.

All four examples illustrated above describe two basic modes of operation, “locked” and “unlocked”, however, other levels of security are of course possible such as:
the user being prompted for a password when the location does not correspond to one of the predefined locations instead of being completely prevented from streaming data on and off the drive as in “locked” mode
access control using decryption of the data wherein decrypted data is only available when the location correspond to one of the predefined locations
access control preventing modification of the data when the location does not correspond to one of the predefined locations

Whilst the invention has been described in the context of GPS, the all weather, spaced based navigation system developed and currently operated by the US Department of Defense, it will be appreciated that the invention is equally applicable to other global positioning systems including GLONASS and Galileo and hybrids thereof. Also, other methods of determining the position include network positioning solutions and simply sharing position information with nearby devices.

1. Storage media for storing data and comprising an integral controller configured to control access to the data depending on the location of the storage media.

2. Storage media as claimed in claim 1 further comprising means to determine its location.

3. Storage media as claimed in claim 1 further comprising a wireless receiver/transmitter for wirelessly streaming the data to and from the storage media.

4. Storage media as claimed in claim 1 wherein the location is provided by an external device.
